(19) United States
(12) Patent Application Publication
(10) Pub. No.: US 2017/0009966 A1
(43) Pub. Date: Jan. 12, 2017

(54) Lighting fixture

(71) Applicant: XIAMEN KONSHINE LIGHTING ELECTRON CO.,LTD, Xiamen (CN)

(72) Inventor: Tianyong ZHANG, Xiamen (CN)

(73) Assignee: XIAMEN KONSHINE LIGHTING ELECTRON CO.,LTD, Xiamen (CN)

(21) Appl. No.: 14/810,499

(22) Filed: Jul. 28, 2015

(30) Foreign Application Priority Data
Jul. 6, 2015 (CN) 201520475839.0

(51) Int. Cl. F21V 21/08

(52) U.S. Cl. CPC F21V 21/08

(57) ABSTRACT

The present disclosure discloses a lighting fixture, which allows for easy installation. The lighting fixture comprises a body and an installation plate. The body comprises a lower cover and an upper cover located above the lower cover. The upper cover comprises a protruding plate and a plurality of pins. The installation plate comprises a groove and a plurality of contact pads. The groove is located at the center of the installation plate and cooperates with the protruding plate. The groove has two clips symmetrically located on the inner side of the peripheral edge of the groove. The clip and the bayonet slot are matched with each other. The two contact pads are symmetrically located on the two sides of the groove and contact with the pin.

### FIELD OF THE DISCLOSURE

The present disclosure relates to a lighting fixture, and more specifically relates to a lighting fixture that allows for easy installation.

### BACKGROUND OF THE DISCLOSURE

Lighting fixture is a device, which transforms electric energy into visible light. Ceiling light, as a kind of lighting fixture, has been widely used for indoor and outdoor scenes. Currently, installation for an ceiling light will generally begin with taking apart the mask of the ceiling light, and then lifting the bottom components, such as light source, power or bottom cap, to fix on the ceiling by drilling holes marked on the ceiling beforehand, after that, fixing the mask of the ceiling light to the bottom components on the ceiling. This kind of installation is complicated for users and usually requires the lighting fixture to be taken apart by professionals.

The present disclosure overcomes the drawbacks by disclosing a lighting fixture, which is easily installed.

### SUMMARY OF THE DISCLOSURE

The purpose of the present disclosure is to provide an alternative lighting fixture that allows for easy installation. One can easily install a lighting fixture by using an installation plate and covering, which is matched with and separated from the installation plate. Now the traditional method of installment, such as taking apart the mask of the lighting fixture and using the markings on the ceiling board, can be avoided. The users can install the lighting fixture without taking apart the lighting fixture, which also allows for convenient transportation and packaging.

In order to achieve the above function, the present disclosure discloses a lighting fixture that allows for easy installation. The lighting fixture generally comprises a. body and an installation plate. The body of the lighting fixture further comprises an upper and lower cover. The upper cover is located on the upper side of the lower cover. Said upper cover comprises a protruding plate and at least One Said protruding plate is located in the Center of the upper cover and the protruding plate further comprises more than one bayonet slot. The two bayonet slots are symmetrical and located on the peripheral edge of the protruding plate. Said pins are located on the two sides of the protruding plate. The installation plate comprises a groove and at least one contact pad. The groove is located in the center of the installation plate and cooperates with the protruding plate. The groove has more than one clip. The two clips are put in Symmetry and located on the inner side of the peripheral edge of the groove. The clip and the bayonet slot cooperate with each other. The two contact pads are put in Symmetry on the two sides of the groove and contact the pin.

In a preferable embodiment, the lighting fixture further comprises at least one installation hole and the installation hole is located on the installation plate.

In another preferable embodiment, the protruding plate has a rounded shape design, and the groove also has a rounded shape design.

In another preferable embodiment, the bayonet slot is L-shaped.

In another preferable embodiment, the lighting fixture further comprises a sub-installation component. The sub-installation component comprises a sub-installation plate and a lamp holder. The sub-installation plate is located on the backside of the installation plate. The lamp holder is located in the center of the sub-installation plate. The lamp holder is electrically connected to the contact pad, which is installed on the installation plate.

In another preferable embodiment, the model of the lamp holder is E 27.

The lighting fixture of the present disclosure can be easily fixed to the ceiling via the installation plate, or quickly installed on the E 27 lamp base via lamp holder, without taking apart the mask of the lighting fixture. Users do not need to disassemble the shell of the lighting fixture in this case, fixing the lighting fixture does not need professional assistance. The users can install the lighting fixture without a professional and is convenient for transportation and packaging.

### BRIEF DESCRIPTION OF THE DRAWINGS

FIG. 1 shows the schematic structure view of the body and installation plate of the lighting fixture.

FIG. 2 shows the schematic structure view of the upper cover

FIG. 3 shows the front schematic structure vim of the installation plate.

FIG. 4 shows the schematic structure view of the lighting fixture with a sub-installation plate.

### DETAILED DESCRIPTION OF THE DISCLOSURE

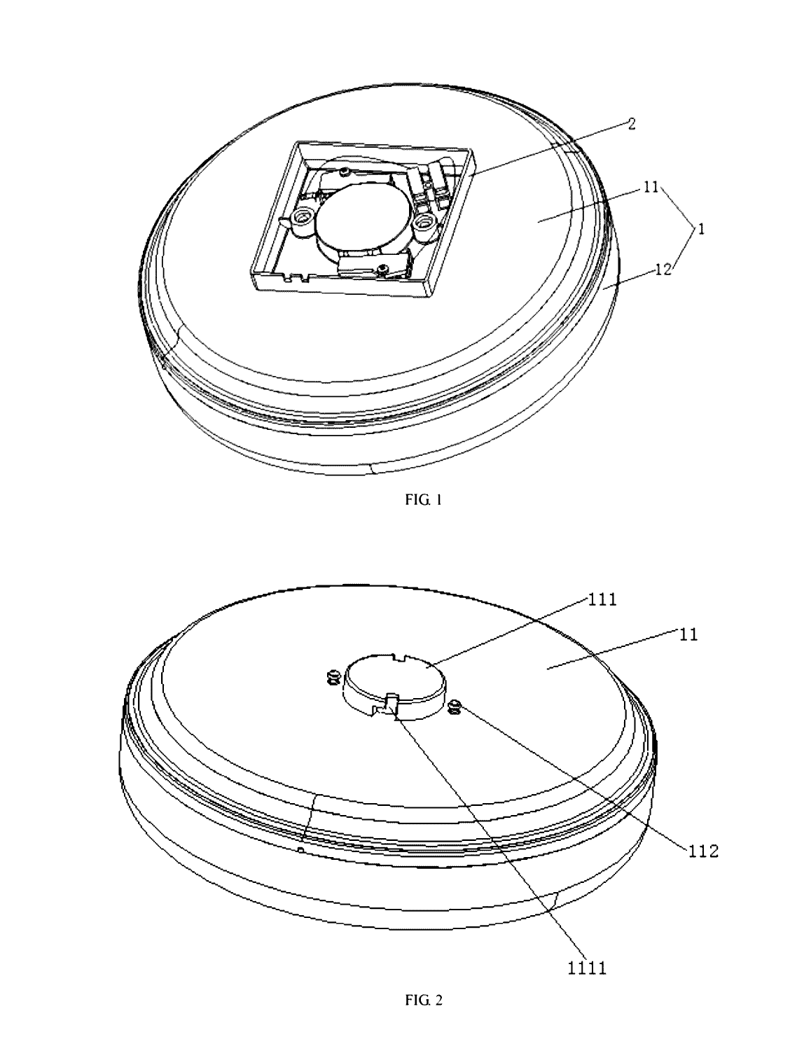

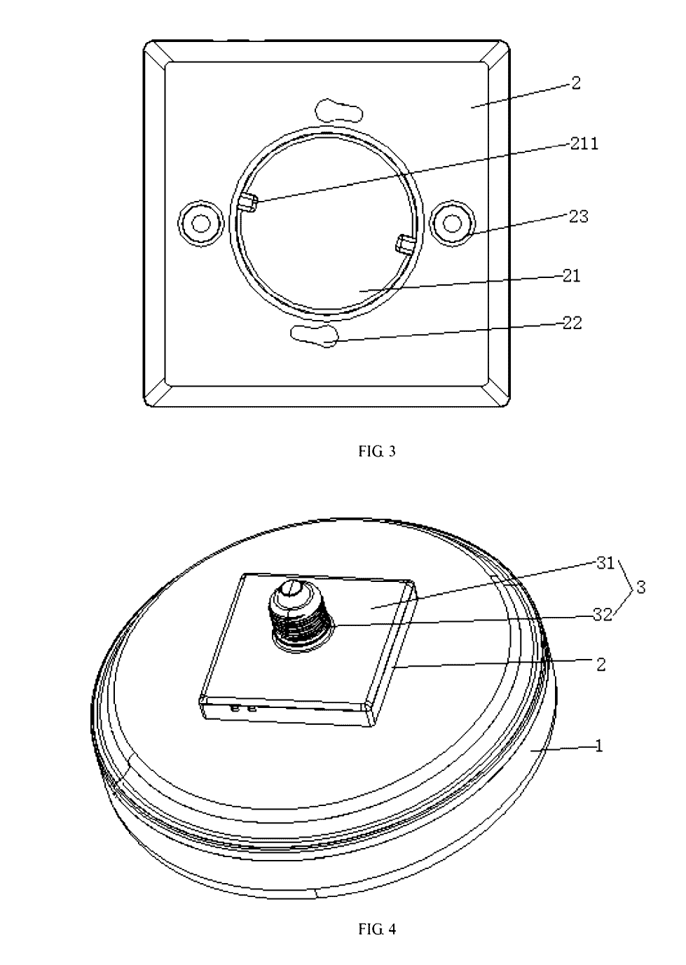

FIGS. 1-4 show an easily installable lighting fixture. The lighting fixture comprises body 1 and installation plate 2. Said body 1 comprises upper cover 11 and lower cover 12. The shape of the upper cover and the lower cover can be round, square or any other shapes. In one embodiment, the shape of the upper cover and lower cover are round, and upper cover 11 is located over lower cover 12. Screwing or clamping the upper and lower covers allows them to be matched. Upper cover 11 comprises protruding plate 111 and at least two pins 112. Protruding plate 111 is located in the center of upper cover 11. The protruding plate comprises at least two bayonet slot 1111, the two bayonet slots are symmetrically arranged on the two sides and located on the edges of protruding plate 111. At least two pins 112 are located on the two sides of protruding plate 111. At least two pins 112 are conductive pins made of metal materials. Installation plate 2 includes groove 21 and contact pad 22 made of metal materials, such as copper and aluminum. Groove 21 is located in the center of installation plate 2. Groove 21 matches with protruding plate 111. Groove 21 further comprises at least two clips 211. At least two clips 211 are symmetrically located on the inner peripheral edge of the groove. Clip 211 matches with bayonet slot 1111. Two contact pads 22 are in direct contact with pin 112, thus the light source and lighting fixture are electrically connected to each other.

In a preferable embodiment, lighting fixture further comprises installation hole 23 located on installation plate 2.

In another preferable embodiment, protruding plate 111 is a round shape, accordingly, groove 21 is also a round shaped groove.

In another preferable embodiment, bayonet slot 1111 is an L-shaped slot.

In another preferable embodiment, the lighting fixture further comprises sub-installation components 3. Sub-installation component 3 comprises sub-installation plate 31 and tamp holder 32. Sub-installation plate 31 is located on the backside of installation plate 2. Lamp holder 32 is located in the center of sub-installation plate 31. Lamp holder 32 is electrically connected to contact pad 22.

In another preferable embodiment, light holder 32 is a model of E 27 and the model is not limited to this type. It can be any other type of lamp holder.

Users can preinstall the installation plate on the ceiling via the installation hole. The body of the lighting fixture is then fixed to the installation plate through the cooperation between the clip and bayonet slot. The lamp base, which has already been installed on the ceiling, can also be installed by using a sub-installation component. First of all, the users can fix the sub-installation plate to the backside of the installation plate, and then install the lighting fixture to the lamp base through the cooperation between the lamp holder and the lamp base.

The lighting fixture of the present disclosure can be directly installed on the ceiling. Or the present disclosure can be used in a situation when the user has already installed the E27 lamp base. The user can also use this type of product without changing the installation method. The traditional way of installation requires the user to remove the E27 Lamp base and take apart the lighting fixture in order to drill a hole, which can now be avoided. Users themselves can replace and clean the lighting, fixture without professional assistance. The present disclosure comprises two separate parts rather than one integral structure, which at the same time provides packaging and transportation convenience. The upper cover and lower cover is sealing against each other, in this case, dust and insects cannot go inside the lighting fixture.

The above embodiments are the descriptions of this disclosure. This disclosure should cover all equivalent modifications and combinations of these embodiments, and is not limited to these embodiments.

1. A lighting fixture that allows for easy installation, comprising:
a body;
an installation plate;
wherein the body comprises a lower cover and an upper cover located above the lower cover; the upper cover comprises a protruding plate located in the center of the upper cover and a plurality of pins; the protruding plate comprises a plurality of bayonet slots symmetrically located on peripheral edge of the protruding plate; the plurality of pins are located on two sides of the protruding, plate: the installation plate comprises a groove and at least two contact pads; the groove is located in the center of the installation plate and matches with the protruding plate, the groove comprises at least two clips symmetrically located on inner peripheral edge of the groove and matched with the plurality of bayonet slots; the at least two contact pads are symmetrically located on the two sides of the groove and contact with the pin.

2. The lighting fixture of claim 1, further comprising at least one installation hole located on the installation plate.

3. The lighting fixture of claim 1, wherein the protruding plate is round shaped; and
wherein the groove is round shaped.

4. The lighting fixture of claim 1, wherein the plurality of bayonet slots are L-shaped.

5. The lighting fixture of claim 1, further comprising a sub-installation component;
wherein the sub-installation component comprises a sub-installation plate and a lamp holder; the sub-installation plate is located on the backside of the installation plate;
the lamp holder is located on the center of the sub-installation plate; and
wherein the lamp holder is electrically connected with the at least two contact pads of the installation plate.

6. The lighting fixture of claim 5, wherein a model of the lamp holder is E 27.
